(19) United States
(12) Patent Application Publication
(10) Pub. No.: US 2008/0063750 A1
(43) Pub. Date: Mar. 13, 2008

(54) Method for making colorless and artificially colored clear beer

(75) Inventors: Alberto D. Rivera, Quezon City (PH); Emiliano S. Macapugay, Quezon City (PH); Jade Y. Decarlos, Manila (PH)

Correspondence Address: EDWARDS ANGELL PALMER & DODGE LLP, P.O. BOX 55874, BOSTON, MA, 02205, US

(73) Assignee: San Miguel Corporation

(21) Appl. No.: 11/789,476

(22) Filed: Apr. 25, 2007

Related U.S. Application Data
(63) Continuation of application No. PCT/PH05/00018, filed on Aug. 26, 2005.

(30) Foreign Application Priority Data
Oct. 25, 2004 (PH) PH2004/000467

(51) Int. Cl. C12C 11/00

(52) U.S. Cl. 426/16; 426/592

(57) ABSTRACT

This invention is directed to a method of preparing a colorless and artificially colored, clear beer through absorption process by contacting the wort with activate carbon during wort boiling. this method produces a colorless, clear beer with originally processed inherent taste and aroma utilizing existing brewery process and equipment. Artificially colored, clear beer such as primary-colored beer, which can be conveniently produced using the colorless, clear product is also disclosed.

### RELATED APPLICATIONS

This is a continuation patent application which claims priority to PCT/PH2005/000018 filed on Aug. 26, 2005, which claims the benefit of PH2004/000467 filed on Oct. 25, 2004. The entire teachings of the above applications are incorporated by reference.

### FIELD OF THE INVENTION

This invention generally relates to process of making beer. More particularly, it relates to a method of making colorless and artificially colored beer. It also relates to colorless, clear beer product and artificially colored beer products such as primary-colored, i.e. blue- or red-colored, clear beer products.

### BACKGROUND OF THE INVENTION

Traditional and conventional beer processes generally produce straw-colored, light yellow to golden yellow, or dark brown beer. In terms of the American Society of Brewing Chemists (ASBC) Standard Reference method (SRM), the natural beer color of regular pale beers register a color reading between 1.5-3.0 SRM units. The natural yellow color in beer is attributed to the inherent color or color precursors of the malt used. The natural color of other components used in brewing beer contributes also to the SRM reading of the beer product. Basically, pale malt contributes a color reading of about 1.5 to 3.0 SRM units to the beer product produced by the conventional and traditional processes.

The natural color of the beer can be attributed to the color of the wort prior to its fermentation. The color of the wort comes from the natural pigmentation of the malt used to prepare the wort and to the pigment melanoidin produced from the reaction of sugar with proteins during mash preparation and wort boiling. In the process of preparing beer, the color of the wort becomes more or less the final color of the beer.

Colorless, clear beer had been made in the past wherein a feed beer is made to undergo a decolorization process. A typical colorless, clear beer has a color reading of less than 0.5 SRM units. Decolorization process (removal of natural yellow color) is normally done in cold process after the fermentation stage or after the brewing process has been completed.

In U.S. Pat. No. 5,439,699, Tripp, et. al. disclose a method of preparing a colorless, clear beer by subjecting a feed beer to ultrafiltration using a membrane with a molecular weight cutoff (MWCO) of 300, and adding dextrins, bittering agents and foam enhancer to the permeate. During the ultrafiltration, beer foam is separated from the permeate, thus there is a need to add a beer foaming component to the permeate to impart a foam to the colorless, clear beer. It is further disclosed that dextrin is added to give the colorless beer some body, sweetness, dryness and balance. The bittering agent is added to replenish some of bitter flavor lost during ultrafiltration. The colorless, clear beer of Tripp, et. al. has a color reading of 0.1 SRM units.

The Tripp patent makes no mention of the filtration cycle times when using the stated membrane, only that filtration is intolerably slow when using lower MWCO levels, an area of concern in typical breweries. The existing method of preparing colorless, clear beer also requires additional equipment, thus, entailing additional cost to the brewer.

Activated carbon is known as an adsorptive material to remove odor and color in substances and compositions. Tripp et. al., in U.S. Pat. No. 5,618,572, teaches the use of activated carbon in preparing a natural beer foam by treating a feed beer and removing the carbon through filtration to obtain a beer with excellent foam and malty flavor. In U.S. Pat. No. 5,439,699, Tripp et. al. disclose that about 0.25 to about 1.0% activated carbon by weight is contacted with a conventional brewed beer for at least 2 minutes at a temperature of about 1 to 30 degrees ° C. to produce a natural beer foaming component for malt beverages.

The use of activated carbon in decolorization process is also disclosed in U.S. Pat. No. 5,294,450 (Word et. al.) in the preparation of colorless, clear malt beverages. In this patent, decolorization is preferably accomplished by contacting the fermented product with activated carbon. An alternative process is also disclosed wherein decolorization may take place after boiling of the wort, but prior to fermentation. However, in either of the two processes of Word et. al., an additional time of at least 12 hours is needed to effect decolorization. In certain cases, for example, there Is a need to repeat the decolorization process in two or more stages to achieve a colorless, clear liquid.

A need exists to find alternative method for preparing colorless, clear beer or malt beverages wherein the decolorization process can be achieved at a relatively shorter time than what is taught by the prior art and without any additional ingredients or elements needed to regain the original flavor and aroma developed during fermentation.

### SUMMARY AND OBJECTS OF THE INVENTION

The present invention seeks to provide a solution to the problems and drawbacks of the prior art by providing an improved method for making colorless, clear beer in which the decolorization process is done during the wort boiling process. This new method reduces the decolorization time to a significant level that is unknown to the prior art and beer-making industry.

The present invention discloses a method of preparing beer generally comprising the general steps of mashing, wort filtration, wort boiling, fermentation and beer filtration, characterized in that, during the wort boiling process, activated carbon is added and allowed to be contacted with the wort for a period of time sufficient to decolorize the wort during boiling, preferably about 30 to 70 minutes, and preferably at a temperature between 100° to 105° C.

In a preferred embodiment of the present invention, colorless and artificially colored, clear beer Is prepared by mashing the malt ingredients; extracting the wort from the mashed malt; contacting the filtered wort with activated carbon for about 30 to 70 minutes during boiling, preferably, about 50 to about 60 minutes, and most preferably about 60 minutes to decolorize the wort to a color reading of less than 0.5 SRM units; separating the activated carbon from the decolorized wort by using known means in the brewing industry such as filtration or centrifugation; cooling the decolorized wort; fermenting the decolorized wort for ca 8 days, preferably, by pitching with yeast at 12 Mcells/mL; filtering the decolorized beer; and collecting the colorless, clear beer. In another preferred embodiment, activated carbon may be separated from the wort after the cooling step and before the fermenting step.

Tetrahop or post-fermentation hop product may be added after filtering the decolorized beer to provide the bitter taste/hop character of the clear, colorless beer. The amount of hops to be added depends on the bitter taste/hop character desired for the beer product.

A method of preparing primary-colored, clear beer is also disclosed in which primary colorant is added to the colorless, clear beer of the present invention, wherein the primary colorant is selected from FD&C (Food, Drug and Cosmetic) Blue #1 and FD&C Red #40 or corresponding permitted natural colorants. The amount of colorant to be added depends on the color tone desired.

The present invention also discloses a novel primary-colored beer, particularly, red- or blue-colored beer.

It is therefore the main object of the present invention to provide a quick, simple and cost-effective method of preparing colorless and artificially colored, clear beer utilizing existing brewery process and equipment wherein the decolorization is made during the wort boiling process and prior to fermentation of the wort to prevent the activated carbon from adsorbing the beer flavor and aroma developed during fermentation, thus the originally processed inherent taste and aroma of the beer are preserved

It is an object of the present invention to provide a more efficient process for preparing colorless and artificially colored, clear beer by significantly and substantially shortening the decolorization time.

Another object thereof is to provide a method of preparing colorless and artificially colored, clear beer that is most practical and economical to engage with In a mass-production set-up, thus, has a great market potential.

Still another object thereof is to provide a method of preparing a colorless and artificially colored, clear beer that can be used as a base beer for preparing a novel artificially colored beer such as primary-colored beer, that is, blue or red beer or any color combination thereof that is highly attractive to consumers.

Another object thereof is to provide a beer product that is colorless and yet has retained the inherent taste and aroma of beer.

These and other objects of the present invention will become apparent and be appreciated upon reading the succeeding brief description of the drawings and detailed description.

### BRIEF DESCRIPTION OF THE DRAWINGS

FIG. 1 is a general flow chart showing the conventional beer brewing process which produces a straw colored beer;

FIG. 2 is a general flow chart showing a method of preparing colorless, clear beer from a feed beer according to the prior art in which decolorization is done after fermentation; and

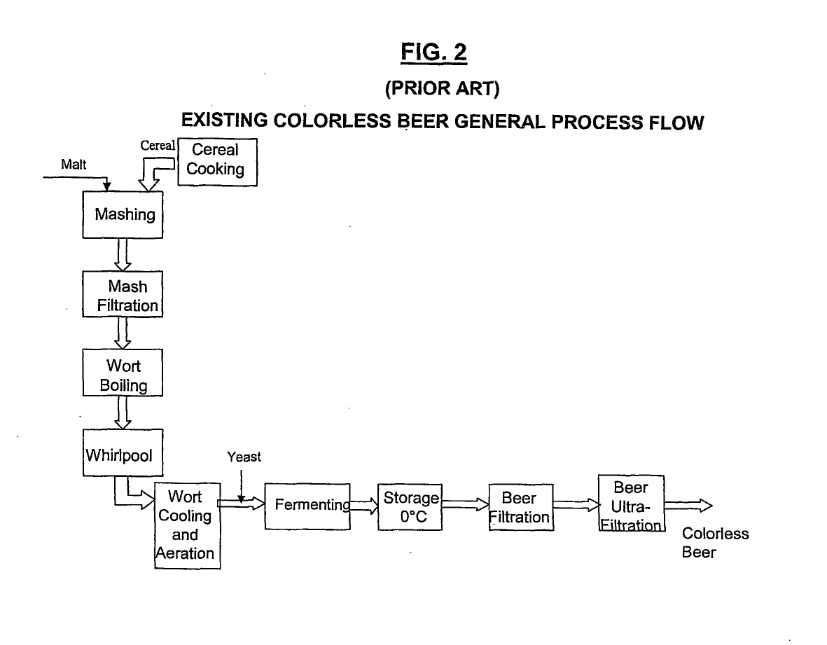

FIG. 3 is a general flow chart showing the method of preparing colorless and artificially colored, clear beer of the present invention in which decolorization is done during boiling of the wort prior to fermentation process.

### DETAILED DESCRIPTION OF THE INVENTION

The method of the present invention can be incorporated in existing typical beer brewing process where a colorless and artificially colored, clear beer is desired to be produced.

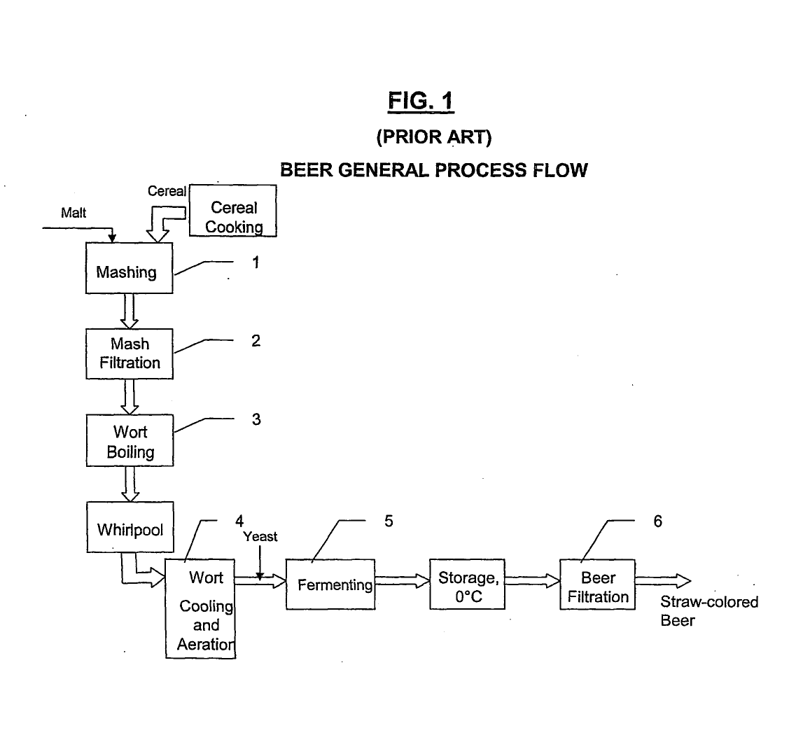

Referring now to the drawing in which like reference numerals designate the same elements all throughout the succeeding description, there is shown in FIG. 1 a typical method of preparing naturally straw-colored beer, generally comprising: mashing the malt and other ingredients 1, filtering the mash mixture to obtain a wort 2, boiling the wort 3, cooling and aerating the wort prior to fermentation 4, fermenting the wort to obtain a beer 5, and finally subjecting the beer to an ordinary filtering process 6 to obtain a straw-colored beer, which normally has a color reading of 1.5 SRM units or more, generally up to 5 SRM units.

“Mashing” as used herein refers to the process of combining malt, water and other ingredients to produce a mixture commonly called “mash”.

“Wort” is the liquid extracted from the mash by filtration or any other conventional means accepted in the brewing industry.

“SRM” or Standard Reference Method is a unit of measurement defined by the American Society of Brewing Chemists to express the amount of color in a brewing liquid.

“FD&C Color # or Food, Drug and Cosmetic Color Number is the colorant number or code defined/provided by the Food and Drug Authority (FDA) on artificial colorants certified for use in the food industry.

“Natural colorants” refer to “FDA certification exempt” colorants derived from natural sources such as plant, minerals or animals governed by specifications and purity requirements.

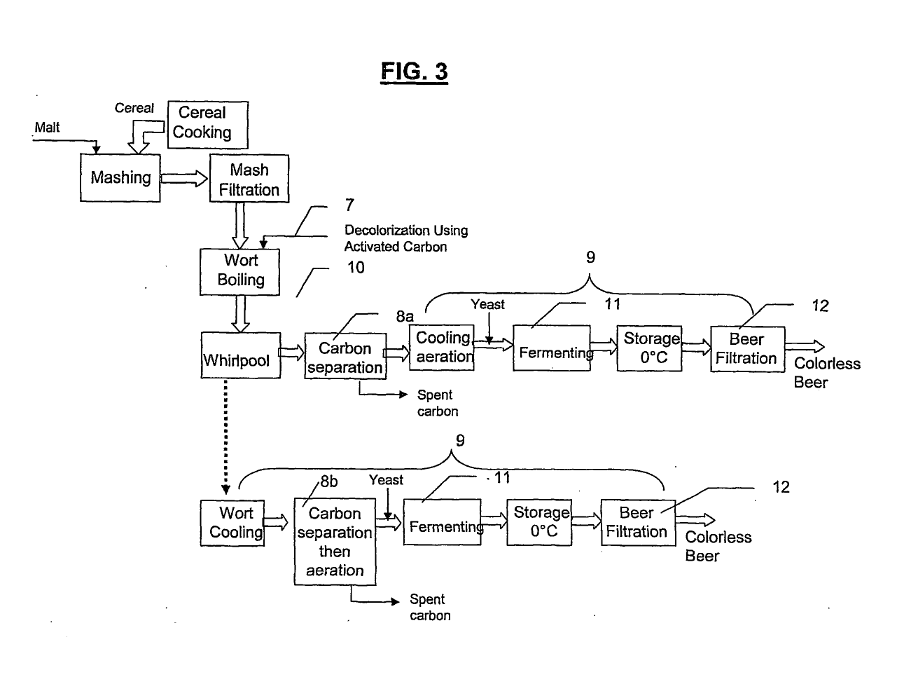

Referring to FIG. 3, a colorless and artificially colored, clear beer is produced with the addition of a decolorization process 7 during wort boiling stage and a separation process 8a or 8b to obtain the decolorized wort. Carbon separation may be done prior to wort cooling (8a) or after wort cooling (8b) depending on current/desired equipment set-up in the brewery. The decolorized wort is then subjected to conventional brewing steps or processes 9 to produce a beer having less than 0.5 SRM which has desirable beer taste and aroma even without the addition of artificial taste enhancers.

The method of the present invention has substantially and significantly reduced the time necessary to effect decolorization of the wort using activated carbon 7 by contacting the activated carbon with the wort all throughout or during a part of the wort boiling process 10. Activated carbon may be added to the wort before it is boiled which allows the activated carbon to be in contact with the wort throughout the wort boiling process 10. In an alternative method, activated carbon may be added to the wort at a certain time after the wort is initially heated which allows the activated carbon to be in contact with the wort during a part of the wort boiling process 10.

According to a preferred embodiment of the present invention, conventional brewing materials such as malt, rice or in combination with other alternative carbohydrate source and water are combined to form a mash.

The teaching of the present invention can be illustrated by describing one preferred embodiment of a method of preparing colorless and artificially colored, clear beer. In accordance with this preferred embodiment, malt and water are combined to form a mash, normally at 45 to 52° C. Other ingredients may then be added such as pre-cooked gelatinized rice or corn cereal to the mash and subjected to a mashing temperature regimen, normally 60 to 65° C. for 30 to 60 minutes, 70 to 72° C. for 20 to 30 minutes, and finally raised to 76° C. The mash is then filtered and the liquid extract known as “wort” is transferred to a kettle for heating/boiling. At this stage, the color of the wort is between 1.5 to 3 SRM units. Just prior to heating and boiling of the wort 10, activated carbon is added and is allowed to be in contact with the wort throughout the heating/boiling stage until the wort is colorless in appearance. Although decolorization is already observed as the wort boils at a temperature of about 100° C. at wort boiling stage 10, decolorization is optimized at a temperature of about 100° C.-103° C. In about 30-minute contact time, the color of the wort may be reduced to about 0.7 SRM units. The wort is allowed to boil up to 70 minutes while in contact with the activated carbon, and color of the wort is further reduced. It should be understood that the rate of decolorization in accordance with the present invention depends on the actual hue of the wort prior to boiling. The amount of activated carbon added per unit volume of the wort also affects the rate of decolorization. It is preferred to use about 1-2 kg activated carbon per hectoliter of wort. Contact time of activated carbon is preferably about 30-70 minutes.

After the boiling stage 10, the spent activated carbon and other residual solids 8a are then separated from the decolorized wort by means of filtration or centrifugation or any other suitable means common in brewery operations. At this stage, the decolorized wort obtained has less than 0.7 SRM units, preferably about 0.3-0.5 SRM units, which has the appearance of a colorless, clear wort. The colorless, clear wort Is then immediately subjected to cooling and aeration. Alternatively, the spent carbon and other residual solids 8b are separated from the decolorized wort after cooling and subsequently aerated.

The cooled colorless, clear wort is then subjected to fermentation 11 for 7-10 days. Fermentation 11 is initiated by adding yeast to the colorless wort. A wide variety of specific yeasts known in the art of brewing beer may be used such as Saccharomyces uvarum and Saccharomyces cerevisiae. The amount of yeast to be added should be at least 12 million cells (Mcells) per mL of the colorless wort. The wort is allowed to ferment completely at operating conditions typical to the fermentation of beer.

After the fermentation 11, the fermented beer is filtered using ordinary filtration means 12 known in the brewing industry in order to remove residual solids and yeasts. The colorless, clear beer with desirable natural beer taste and aroma is collected

Bittering agents such as tetrahops and other hop/hop-derived products may be added prior to packaging if a stronger bitter taste/hop character is desired.

The activated carbon (referred herein also as carbon) suitable for use during the decolorization process is a food grade activated carbon having high adsorptive capacity and optimum pore size such that it has least effect on the malt flavor character of the wort. The high adsorptive capacity of activated carbon is measured by Molasses number (EUR) or methylene blue adsorption (MBA) of carbon. It is preferred to use carbon with Molasses number greater than 150 and MBA in the range of 5-30 g/100 g methylene blue. Examples of such activated carbon for use in the present invention are Norit CN Extra, Norit ZN-5, Norit CASP(F) and DarcoA51 manufactured and sold by American Norit Company, Inc. CASP(F) is preferably used by the present invention.

Notwithstanding the foregoing preferred embodiment, the decolorized wort of the present invention can also be utilized as a base liquid for preparing colorless malt beverages. The colorless, clear beer produced by the method of the present Invention is a perfect base beer for producing artificially colored beer.

In another embodiment of the invention, there is provided a method of preparing primary-colored, clear beer by further adding to the colorless, clear beer a primary colorant selected from blue and red color which may be synthetic or natural colorant. The preferred colorant used by the present invention is selected from FD&C Blue #1 and FD&C Red #40. The amount of colorant to be added depends on the hue and tone desired to be achieved. It is preferred to add about 5-15 ppm of colorant to the colorless, clear beer.

The following examples are given to illustrate the practice of the present invention and the same should not be interpreted to limit the teaching of the present invention.

### EXAMPLE 1

Preparation of Filtered Wort

A wort (13° Plato) was prepared from the following ingredients:

| | |
|---|---|
| Pale malt, kgs. | 329 |
| Pre-cooked gelatinized rice, kgs. | 210 |
| Foundation water, hLs | 1 |
| Total mash-in water, hLs | 17 |
| Sparge water, hLs | 19 |

The ingredients were mashed at 50° C. for 30 minutes, then the temperature was raised to 65° C. and held for 30 minutes and then raised to 72° C. then held for 20 minutes and finally raised to 76° C. The mixture was then filtered to obtain a filtered wort.

### EXAMPLE 2

Preparation of Clear, Colorless Beer

The filtered wort is placed in a boiler and a food grade CASP(F) activated carbon was added to the filtered wort, then the filtered wort, together with the activated carbon, was boiled for 60 minutes at 100° C., allowing the activated carbon to be In contact with the filtered wort during boiling to adsorb the color of the wort. After boiling and cooling, the activated carbon was then separated from the decolorized wort by filtration. After separating the carbon, the decolorized wort was aerated, and then pitched with 12 Mcells/mL yeast and allowed to ferment for 8 days. The fermented solution was then filtered and the colorless, clear beer was collected. 10 ppm Tetrahop were then added.

Typical finished beer upon dilution would be around 10.5° Plato Original Gravity, 3.80% Alcohol by weight and 10 BU and 0.3 SRM.

### EXAMPLE 3

Preparation of a clear, Colorless Beer

After boiling the wort with activated carbon as in Example 2, the activated carbon was then filtered and immediately cooled by passing through a plate heat exchanger and collected in a tank. The decolorized wort was then aerated, and pitched with 12 Mcells/mL yeast and allowed to ferment for 8 days. The fermented solution was then filtered and the colorless, clear beer was collected. 10 ppm Tetrahop were then added.

### EXAMPLE 4

Preparation of a clear, Colorless Beer

Filtered wort from example I were treated as in example 2 but using Darco A51 activated carbon.

### EXAMPLE 5

Preparation of Primary Colored Beer (Blue-Colored Beer)

Colorless, clear beer was prepared as in examples 2 and 3, and about 10 ppm of colorant FD&C blue #1 (Brilliant Blue FCF) was added to the colorless, clear beer to produce a blue colored beer.

### EXAMPLE 6

Preparation of Primary Colored Beer (Red-Colored Beer)

Colorless, clear beer was prepared as in examples 2 and 3, and about 10 ppm of colorant FD&C Red #40 (Allura Red) was added to the colorless, clear beer to produce a red colored beer.

Although some other embodiments of this invention have not all been described or shown in this disclosure, they should be considered as falling within the spirit, teaching and scope of this invention as set forth in the following claims.

What is claimed is:

1) A method of preparing beer comprising the steps of mashing, wort filtration, wort boiling, fermentation and beer filtration; characterized in that, activated carbon is contacted with the wort for sufficient time during wort boiling to reduce the color of the wort to less than 0.7 SRM units.

2) A method according to claim 1 wherein the contact time is between 30 to 70 minutes.

3) A method according to claim 1 wherein the temperature of the wort during wort boiling is about 100° C. to about 105° C.

4) A method according to claim 1 wherein the amount of activated carbon is about 1.0% to about 2.0% by weight of the wort.

5) A method according to claim 1 wherein the contact time is between 30 to 70 minutes and the temperature of the wort is between 100-105° C.

6) A method according to claim 1 wherein the activated carbon has an adsorptive capacity of greater than 150 Molasses number and Methylene Blue adsorption of 5-30 g/100 g methylene blue.

7) A method according to claim 2 wherein contact time is about 60 minutes.

8) A method of preparing beer comprising:
a) preparing a mash by combining malt, water, and adjunct;
b) filtering the mash to extract the wort;
c) contacting the filtered wort with activated carbon during wort boiling to reduce color of the wort to about less than 0.7° SRM units, with subsequent addition of hops;
d) cooling the decolorized wort;
e) aerating the decolorized wort;
f) fermenting the decolorized wort to produce fermented beer;
g) filtering the fermented colorless, clear beer; and
h) collecting the colorless, clear beer.

9) A method according to claim 8 wherein the fermentation in step (f) is initiated by adding yeast in an amount sufficient to achieve a yeast cell count of at least 12 Mcells/mL of the decolorized wort and the fermentation is allowed to complete for 7-10 days.

10) A method of preparing an artificially colored, clear beer comprising adding a food colorant to the colorless, clear beer made by the method of claim 1 or claim 8.

11) A method according to claim 10 wherein the colorant is selected from natural colorants and synthetic Food, Drug and Cosmetic (FD&C) standard colorants.

12) A method according to claim 11 wherein said colorant is a primary colorant selected from red and blue.

13) A colorless, clear beer made by the method of claim 1 or claim 8.

14) An artificially colored, clear beer made according to the method of claim 10.

15) A primary-colored, clear beer made according to the method of claim 12.

16) A method according to claim 8 wherein the activated carbon is separated from the decolorized wort between step (c) and (d).

17) A method according to claim 8 wherein the activated carbon is separated from the decolorized wort between step (d) and (e).
